(19) United States
(12) Patent Application Publication
(10) Pub. No.: US 2011/0164578 A1
(43) Pub. Date: Jul. 7, 2011

(54) METHOD AND SYSTEM FOR MULTIBAND USER SCHEDULING IN A MULTIPLE USER MULTIPLE INPUT MULTIPLE OUTPUT (MU-MIMO) COMMUNICATION SYSTEM

(76) Inventors: Joonsuk Kim, Saratoga, CA (US); Sirikiat Lek Ariyavisitakul, Alpharetta, GA (US)

(21) Appl. No.: 12/720,945

(22) Filed: Mar. 10, 2010

Related U.S. Application Data
(60) Provisional application No. 61/292,688, filed on Jan. 6, 2010.

(51) Int. Cl. H04W 72/04

(52) U.S. Cl. 370/329

(57) ABSTRACT

A method and system for multiband user scheduling in a multiple user multiple input multiple output (MU-MIMO) communication system are presented. In one aspect of the method and system a plurality of users in a user group may be selectively assigned to individual frequency bands among a plurality of frequency bands (referred to as a multiband). In an exemplary aspect, a modified greedy user scheduling algorithm may be utilized for assigning users, selected from the user group, to each of the frequency bands. Assigned users for a given frequency band are determined based on channel norm values computed for each of the users in the user group and on chordal distances computed between users in the user group. Pairs of users, selected from the user group, are assigned to each frequency band in the multiband to maximize aggregate data rate capacity for the MIMO communication system.

### CROSS-REFERENCE TO RELATED APPLICATIONS/INCORPORATION BY REFERENCE

This application makes reference to, claims priority to, and claims the benefit of U.S. Provisional Application Ser. No. 61/292,688, filed Jan. 6, 2010, which is incorporated herein by reference in its entirety.

### FIELD OF THE INVENTION

Certain embodiments of the invention relate to communication networks. More specifically, certain embodiments of the invention relate to a method and system for multiband user scheduling in a multiple user multiple input multiple output (MU-MIMO) communication system.

### BACKGROUND OF THE INVENTION

Mobile communication has changed the way people communicate and mobile phones have been transformed from a luxury item to an essential part of every day life. The use of mobile phones is today dictated by social situations, rather than hampered by location or technology. While voice connections fulfill the basic need to communicate, and mobile voice connections continue to filter even further into the fabric of every day life, the mobile Internet is the next step in the mobile communication revolution. The mobile Internet is poised to become a common source of everyday information, and easy, versatile mobile access to this data will be taken for granted.

Single user MIMO (SU-MIMO) systems enable high speed wireless communications by concurrently transmitting multiple data streams using a plurality of NTX transmitting antennas at a transmitting station. The concurrently transmitted data streams may be received at a receiving station using a plurality of NRX receiving antennas. The Shannon capacity refers to a measure of the maximum data rate for communications between the transmitting station and the receiving station. In SU-MIMO systems, Shannon capacity may be achieved by closed-loop beamforming, link adaptation and/or successive interference cancellation (SIC) techniques.

In comparison to SU-MIMO systems, with MU-MIMO systems, a transmitting station may concurrently transmit multiple data streams, using a plurality of NTX transmitting antennas, which may be concurrently received by multiple receiving stations, where each of the receiving stations may utilize NRX receiving antennas. MU-MIMO systems may support the concurrent transmission of a larger number of data streams, using a larger number of transmitting antennas, relative to SU-MIMO systems.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A method and system multiband user scheduling in a multiple user multiple input multiple output (MU-MIMO) communication system, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a block diagram of an exemplary MIMO transceiver, which may be utilized in connection with an embodiment of the invention.

FIG. 2 is a block diagram of an exemplary multiple user MIMO system, which may be utilized in connection with an embodiment of the invention.

FIG. 3 is a diagram that illustrates exemplary multiband user scheduling in a multiple user multiple input multiple output (MU-MIMO) communication system, in accordance with an embodiment of the invention.

FIG. 4 is a flowchart that illustrates exemplary steps for multiband modified greedy user scheduling in a MU-MIMO communication system, in accordance with an embodiment of the invention.

FIG. 5 is a flowchart that illustrates exemplary steps for frequency band ordering based on a channel norm value for multiband user scheduling in a MU-MIMO communication system, in accordance with an embodiment of the invention.

### DETAILED DESCRIPTION OF THE INVENTION

Certain embodiments of the invention may be found in a method and system for multiband user scheduling in a multiple user multiple input multiple output (MU-MIMO) communication system. Various embodiments of the invention comprise a method and system for assigning users in a MU-MIMO system to selected frequency bands among multiple frequency bands (referred to as a multiband). In an exemplary embodiment of the invention, a modified greedy user scheduling algorithm is utilized for assigning users in each of the frequency bands. Candidate users for a given frequency band are determined based on maximum channel norm values for users in the frequency band and chordal distances computed between users in the frequency band. In an exemplary embodiment of the invention, a pair of users is assigned to each frequency band in the multiband in such a manner as to maximize aggregate data rate capacity for the multiband.

In various embodiments of the invention, an order for making frequency assignments may be determined by computing channel norm values for each user in each of the frequency bands. In such embodiments, the first frequency band for which user assignments are made is determined based on the frequency band for which the largest channel norm is computed.

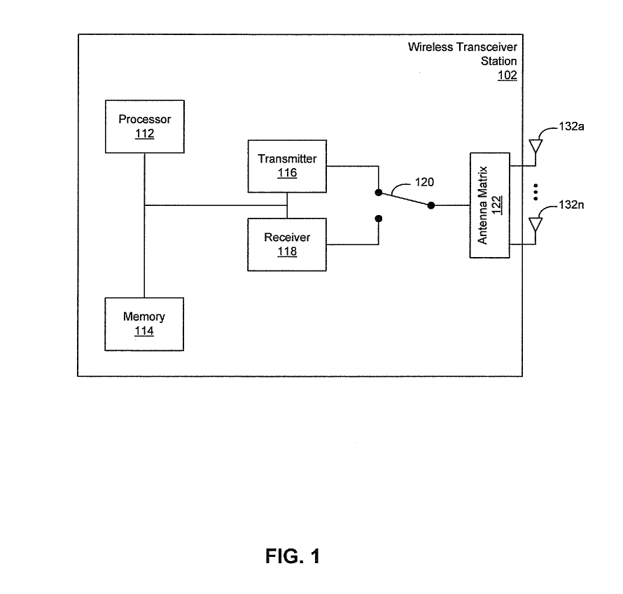

FIG. 1 is a block diagram of an exemplary MIMO transceiver, which may be utilized in connection with an embodiment of the invention. Referring to FIG. 1, there is shown a wireless transceiver station 102 and a plurality of antennas 132a . . . 132n. The wireless transceiver station 102 is an exemplary wireless communication device, which may be utilized at an access point (AP) device or at a station (STA) device in a wireless communication system. The plurality of antennas 132a . . . 132n may enable the wireless transceiver station 102 to transmit and/or receive signals, for example radio frequency (RF) signals, via a wireless communication medium. The wireless transceiver station 102 shown in FIG. 1 may also be depicted as comprising one or more transmitting antennas, which are coupled to the transmitter 116 and one or more receiving antennas, which may be coupled to the receiver 118 without loss of generality.

The exemplary wireless transceiver station comprises a processor 112, a memory 114, a transmitter 116, a receiver 118, a transmit and receive (T/R) switch 120 and an antenna matrix 122. The antenna matrix 122 may enable selection of one or more of the antennas 132a . . . 132n for transmitting and/or receiving signals at the wireless transceiver station 102. The T/R switch 120 may enable the antenna matrix 122 to be communicatively coupled to the transmitter 116 or receiver 118. When the T/R switch 120 enables communicative coupling between the transmitter 116 and the antenna matrix 122, the selected antennas 132a . . . 132n may be utilized for transmitting signals. When the T/R switch 120 enables communicative coupling between the receiver 118 and the antenna matrix 122, the selected antennas 132a . . . 132n may be utilized for receiving signals.

The transmitter 116 may enable the generation of signals, which may be transmitted via the selected antennas 132a . . . 132n. The transmitter 116 may generate signals by performing coding functions, signal modulation and/or signal modulation. In various embodiments of the invention, the transmitter 116 may enable generation of signals using precoding and/or beamforming techniques.

The receiver 118 may enable the processing of signals received via the selected antennas 132a . . . 132n. The receiver 118 may generate data based on the received signals by performing signal amplification, signal demodulation and/or decoding functions. In various embodiments of the invention, the receiver 118 may enable generation of data, which may be utilized by the transmitter 116 for precoding and/or beamforming of generated signals.

The processor 112 may enable the generation of transmitted data and/or the processing of received data. The processor 112 may generate data, which is utilized by the transmitter 116 to generate signals. The processor 112 may process data generated by the receiver 118. In various embodiments of the invention in a node B, the processor 112 may process data received by the receiver 118 and generate coefficient data, which may be utilized by the transmitter 116 for precoding and/or beamforming of generated signals. The coefficient data may be stored in the memory 114.

In various embodiments of the invention, in an AP, the processor 112 may be operable to assign users in a MU-MIMO system to selected frequencies within a multiband in such a manner so as to maximize the aggregate capacity of the MU-MIMO communication system. The transmitter 116 may utilize the user frequency assignments to generate signals that are transmitted to a plurality of users via the transmitting antennas 132a . . . 132n.

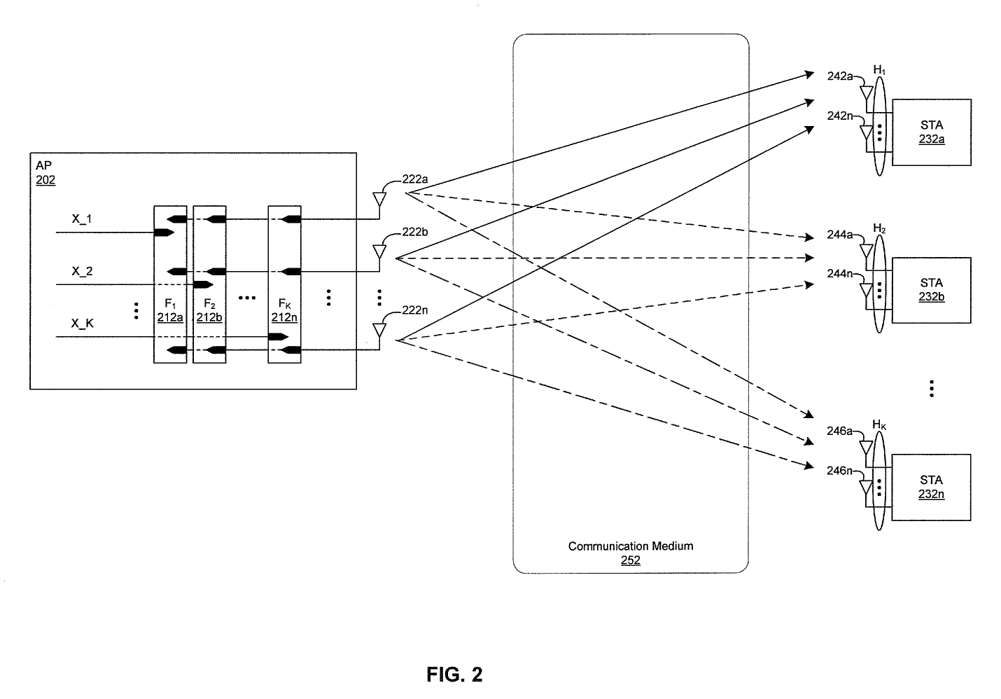

FIG. 2 is a block diagram of an exemplary multiple user MIMO system, which may be utilized in connection with an embodiment of the invention. Referring to FIG. 2, there is shown an AP 202 with a plurality of transmitting antennas 222a, 222b, . . . , 222n, a STA 232a with a plurality of antennas 242a . . . 242n, a STA 232b with a plurality of antennas 244a . . . 244n, a STA 232n with a plurality of antennas 246a . . . 246n, and a communication medium 252. The number of STAs 232a, 232b, . . . , 232n may be represented by the quantity K. In an exemplary embodiment of the invention, each of the STAs may correspond to a user. The antennas 242a . . . 242n, 244a . . . 244n and/or 246a . . . 246n may be utilized for transmission and/or reception of signals at each of the STAs 232a, 232b and 232n, respectively. The number of antennas at each of the STAs may be represented by the quantity M. However, in various embodiments of the invention, the number of antennas at any given STA may be independently determined. The AP 202 may comprise a plurality of beamformer blocks F₁ 212a, F₂ 212b and F_{K} 212n. The number of transmitting antennas 222a, 222b, . . . , 222n may be represented by the quantity N. The AP 202 and STAs 232a, 232b, . . . , 232n may comprise suitable logic, circuitry and/or code that may be operable to perform the functions, processes, operations and/or methods described herein.

In an exemplary embodiment of the invention, the AP 202 may concurrently transmit a plurality of K sets data streams, X₁, X₂, . . . , X_{K}. In an exemplary embodiment of the invention, each of the data stream sets Xᵢ may represent a plurality of L data streams. As shown in FIG. 2, each set data streams may be input to a corresponding one of the beamformer blocks. For example, as shown in FIG. 2, data stream set X₁ is coupled as an input to the beamformer block F₁ 212a, data stream set X₂ is coupled as an input to the beamformer block F₂ 212b, . . . , data stream set X_{K} is coupled as an input to beamformer block F_{K} 212n. Each of the beamformer blocks 212a, 212b, . . . , 212n may be coupled to the plurality of transmitting antennas 222a, 222b, . . . , 222n. Each of the beamforming blocks 212a, 212b, . . . , 212n may utilize corresponding beamforming matrices, F₁, F₂, . . . , F_{K}, to generate a plurality of transmit chain signals, which are concurrently transmitted via the plurality of N transmitting antennas 222a, 222b, . . . , 222n. The transmitted signals may propagate across the communication medium 252. In an exemplary embodiment of the invention, the AP 202 may concurrently transmit signals generated from a plurality of K·L data streams. In various embodiments of the invention, N≧K·L.

The concurrently transmitted signals from the AP 202 may propagate across the communication medium 252 to be received via the plurality of M antennas 242a, . . . , 242n at STA 232a. The communication channel from the AP 202 to the STA 232a may be characterized by a channel estimate matrix H₁, which is based on the signals concurrently transmitted by the plurality of N transmitting antennas and received via the plurality of M receiving antennas. The concurrently transmitted signals from the AP 202 may propagate across the communication medium 252 to be received via the plurality of M antennas 244a, . . . , 244n at the STA 232b. The communication channel from the AP 202 to the STA 232b may be characterized by a channel estimate matrix H₂. The concurrently transmitted signals from AP 202 may propagate across the communication medium 252 to be received via the plurality of M antennas 246a, . . . , 246n at STA 232n. The communication channel from the AP 202 to the STA 232n may be characterized by a channel estimate matrix H_{K}. In various embodiments of the invention, M≧L.

In an exemplary embodiment of the invention, each STA may utilize a corresponding matched filter matrix, Wᵢ, to selectively receive a corresponding one of the K sets of data streams, X₁, X₂, . . . , X_{K}. For example, the STA 232a may utilize a matched filter matrix W₁, to selectively receive data stream set X₁, the STA 232b may utilize a matched filter matrix W₂, to selectively receive data stream set X₂, . . . , the STA 232n may utilize a matched filter matrix W_{K}, to selectively receive data stream set X_{K}.

In various embodiments of the invention, the AP 202 may transmit signals to the STAs by utilizing a plurality of frequency bands within a multiband. Each frequency band may comprise a RF channel bandwidth, which may be configured independently with respect to other frequency bands within the multiband. The AP 202 may assign a subset of the user STAs to each frequency band within the multiband. In an exemplary embodiment of the invention, 2 user STAs may be assigned to each frequency band. The AP 202 may determine the user frequency band assignments in such a manner so as to maximize the aggregate data rate capacity for the communication channels characterized by channel estimate matrices H₁, H₂, . . . , H_{K}. Once user frequency band assignments have been made, the AP 202 may utilize the assigned frequencies to generate signals, which are transmitted to corresponding user STAs. The AP 202 may concurrently transmit signals for generated signals across the frequency bands within the multiband.

In the exemplary embodiment of the invention, each of the STAs receives L spatial streams and utilizes a plurality of M receiving antennas, but various embodiments of the invention are not so limited. Various embodiments of the invention may also be practiced when the number of spatial stream in each spatial stream set and the number of receiving antennas at each STA are independently selected.

The communication system illustrated in FIG. 2 may be represented as shown in the following equation:

$$\begin{matrix}( \begin{matrix}{R}_{1} \\ ⋮ \\ {R}_{K}\end{matrix} ) = ( \begin{matrix}{H}_{1} \\ ⋮ \\ {H}_{K}\end{matrix} ) ( \begin{matrix}{F}_{1} & … & {F}_{K}\end{matrix} ) ( \begin{matrix}{X}_{1} \\ ⋮ \\ {X}_{K}\end{matrix} ) + ( \begin{matrix}{n}_{1} \\ ⋮ \\ {n}_{K}\end{matrix} ) & [ 1 ] \\ ( \begin{matrix}{R}_{1} \\ ⋮ \\ {R}_{K}\end{matrix} ) = ( \begin{matrix}{H}_{1} {F}_{1} & … & {H}_{1} {F}_{K} \\ ⋮ & ⋱ & ⋮ \\ {H}_{K} {F}_{1} & … & {H}_{K} {F}_{K}\end{matrix} ) ( \begin{matrix}{X}_{1} \\ ⋮ \\ {X}_{K}\end{matrix} ) + ( \begin{matrix}{n}_{1} \\ ⋮ \\ {n}_{K}\end{matrix} ) & [ 2 ]\end{matrix}$$

where R₁ . . . R_{K} represent received signal vectors of signals received at each corresponding STA, H₁ . . . H_{K} represent channel estimate matrices associated with the communication channels from AP 202 to each corresponding STA, F₁ . . . F_{K} represent beamforming matrices associated with corresponding beamforming blocks 212a, 212b, . . . , 212n located at the AP 202, X₁ . . . X_{K} represent data vectors for each of the plurality of spatial stream sets generated at the AP 202 and n₁ . . . n_{K} represent noise vectors for channel noise associated with the communication medium 252.

Referring to equation [1], and in an exemplary embodiment of the invention in which the AP 202 comprises N transmitting antennas and generates a plurality of K data vectors, each of which comprises L data streams, and in an exemplary MU-MIMO communication system in which there is a plurality of K STAs, each of which utilizes a plurality of M antennas.

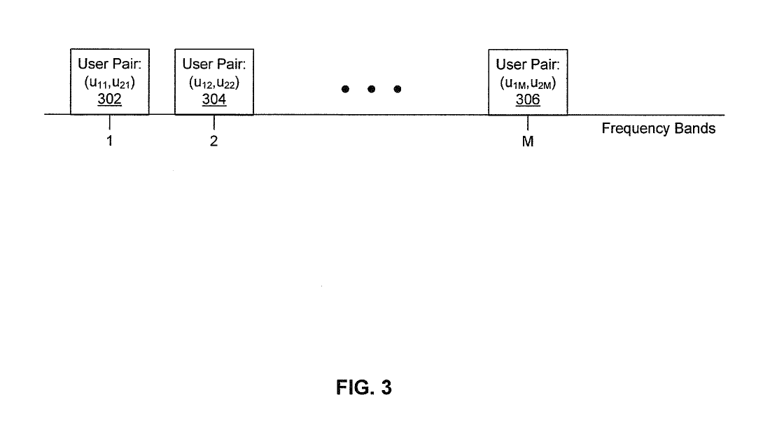

FIG. 3 is a diagram that illustrates exemplary multiband user scheduling in a multiple user multiple input multiple output (MU-MIMO) communication system, in accordance with an embodiment of the invention. Referring to FIG. 3, there is shown a plurality of user pairs, 302, 304, . . . , 306. Each user pair comprises a tuple (u₁ᵢ,u₂ᵢ), which is transmitted within an assigned frequency band i. In the tuple (u₁ᵢ,u₂ᵢ), u₁ᵢ represents a first user selected from the plurality of K users, which is assigned to frequency band i, while u₂ᵢ represents a second user selected from the plurality of K users, which is assigned to frequency band i. User pair 302 (u₁₁,u₂₁) comprises users assigned to frequency band 1, user pair 304 (u₁₂,u₂₂) comprises users assigned to frequency band 2, . . . , and user pair 306 (u_{1M},u_{2M}) comprises users assigned to frequency band M. In an exemplary embodiment of the invention, M=K/2.

In various embodiments of the invention, user pairs (u₁ᵢ,u₂ᵢ) may be constructed in such a manner so as to maximize the average capacity across the multiband as shown in the following equation:

$$\overline{C} = \frac{1}{M} {\sum }_{f = 1}^{M} {\sum }_{i = 1}^{2} {C}_{i}^{f} \qquad [ 3 ]$$

where Cᵢ^{f} represents the capacity of user i evaluated at frequency band f, and C̅ represents the average capacity across frequency bands. In various embodiments of the invention, each capacity value, Cᵢ^{f}, may be represented as shown in the following equation:

$$\begin{matrix}{C}_{i}^{f} = {log}_{2} ( det ⌊ I + {F}_{i}^{H} ( f ) {H}_{i}^{H} ( f ) {( {D}_{i} ( f ) )}^{- 1} {H}_{i} ( f ) {F}_{i} ( f ) ⌋ ) & [ 4 ] \\ where \text{:} & \\ {D}_{i} ( f ) = {H}_{i} ( f ) ( {\sum }_{k \neq i} {F}_{k} ( f ) {F}_{k}^{H} ( f ) ) {H}_{i}^{H} ( f ) + I {σ}^{2} & [ 5 ]\end{matrix}$$

where i represents a user index corresponding to one of the plurality of K STAs 232a, 232b, . . . , 232n, matrix Hᵢ(f) represents the channel estimate matrix for user i evaluated at frequency band f, matrix Fᵢ(f) represents the beamforming matrix for user i evaluated at frequency band f, matrix A^{H} represents a complex conjugate (or Hermitian transformed) version of matrix A, matrix A⁻¹ represents an inverse version of matrix A, matrix I represents an identity matrix and σ² represents noise power at each receiving antenna. In various embodiments of the invention, noise power corresponds to an additive white Gaussian noise (AWGN) channel.

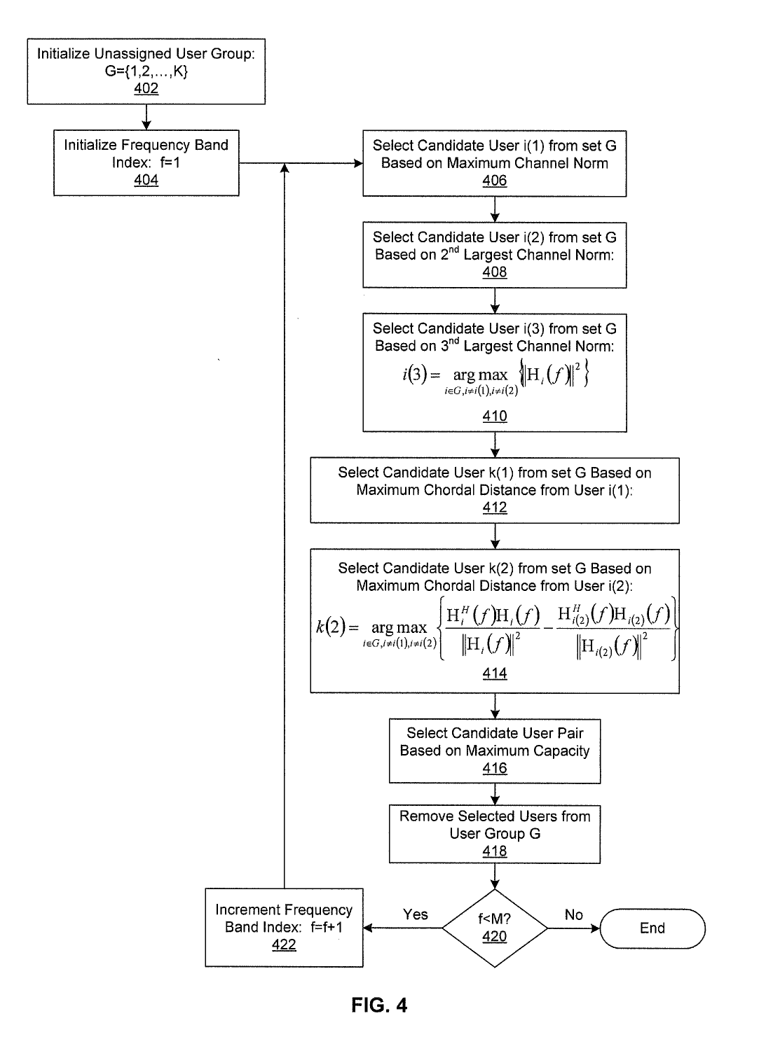

FIG. 4 is a flowchart that illustrates exemplary steps for multiband modified greedy user scheduling in a MU-MIMO communication system, in accordance with an embodiment of the invention. Referring to FIG. 4, in step 402, the unassigned user group, G, may be initialized to comprise the set of K users. In step 404, the frequency band index is initialized, f=1. In step 406, a candidate user i(1) is selected from user group G based a computed maximum channel norm value as shown in the following equation:

$$i ( 1 ) = {arg max}_{i ∈ G} \{ {‖ {H}_{i} ( f ) ‖}^{2} \} \qquad [ 6 ]$$

where i(1) represents an index from user group G, ∥Hᵢ(f)∥² represents a channel norm for user channel Hᵢ evaluated at frequency channel f, and i represents a user index within user group G. In an exemplary embodiment of the invention, the computed channel norm, ∥Hᵢ(f)∥², is a Frobenius norm.

In step 408, a candidate user i(2) is selected from user group G based on a second largest computed channel norm value as shown in the following equation:

$$i ( 2 ) = {arg max}_{i ∈ G , i \neq i ( 1 )} \{ {‖ {H}_{i} ( f ) ‖}^{2} \} \qquad [ 7 ]$$

where i(2) represents an index from user group G.

In step 410, a candidate user i(3) is selected from user group G based on a third largest computed channel norm as shown in the following equation:

$$i ( 3 ) = {arg max}_{i ∈ G , i \neq i ( 1 ) , i \neq i ( 2 )} \{ {‖ {H}_{i} ( f ) ‖}^{2} \} \qquad [ 8 ]$$

where i(3) represents an index from user group G.

In step 412, a candidate user k(1) is selected from user group G based on a computed maximum chordal distance from candidate user i(1) as shown in the following equation:

$$k ( 1 ) = {arg max}_{i ∈ G , i \neq i ( 1 )} \{ \frac{{H}_{i}^{H} ( f ) {H}_{i} ( f )}{{‖ {H}_{i} ( f ) ‖}^{2}} - \frac{{H}_{i ( 1 )}^{H} ( f ) {H}_{i ( 1 )} ( f )}{{‖ {H}_{i ( 1 )} ( f ) ‖}^{2}} \} \qquad [ 9 ]$$

where k(1) represents an index from user group G.

In step 414, a candidate user k(2) is selected from user group G based on a computed maximum chordal distance from candidate user i(2) as shown in the following equation:

$$k ( 2 ) = {arg max}_{i ∈ G , i \neq i ( 1 ) , i \neq i ( 2 )} \{ \frac{{H}_{i}^{H} ( f ) {H}_{i} ( f )}{{‖ {H}_{i} ( f ) ‖}^{2}} - \frac{{H}_{i ( 2 )}^{H} ( f ) {H}_{i ( 2 )} ( f )}{{‖ {H}_{i ( 2 )} ( f ) ‖}^{2}} \} \qquad [ 10 ]$$

where k(2) represents an index from user group G.

Based on steps 406, 408, 410, 412, and 414, the possible user pairs for frequency channel f are (i(1),i(2)), (i(1),i(3)), (i(1),k(1)), (i(2),k(2)) and (i(2),i(3)). For each potential user pair a capacity value is computed as shown in the following equation:

$${\overline{C}}^{f} = {\sum }_{i = 1}^{2} {C}_{i}^{f} \qquad [ 11 ]$$

where C̅^{f} represents the aggregate capacity for frequency band f.

In step 416, the candidate user pair for which capacity, as computed in equation [11] is maximized, is selected.

In step 418, the users selected in step 416 are removed from the user group G. Step 420 determines whether the current frequency band index is the last index within the multiband. In step 420, in instances where f<M, there are additional available frequency indexes within the multiband. In step 422, the frequency band index is incremented, f=f+1. Step 406 follows step 422, and user assignments are made for the next frequency band in the multiband based on the current user group G. In step 420, in instances where there are no additional frequency indexes within the multiband, the frequency band assignment process may terminate.

In various embodiments of the invention where M>K/2, the frequency band assignment process illustrated in FIG. 4 may terminate when there are no further users in the user group G. The frequency band assignment process may be repeated. In an exemplary embodiment of the invention, the AP 202 may repeat the frequency band assignment process during each transmission opportunity in which the AP 202 transmits signals to the STAs. In other embodiments of the invention, the AP 202 may repeat the frequency band assignment process when a channel estimate matrix H₁ is modified or updated. A channel estimate matrix may be updated based on signals received at AP 202 from a STA and/or based on feedback information, which comprises channel estimation data, which is sent from a STA to AP 202.

In various embodiments of the invention, frequency bands may be arranged in any order. For example, user assignments may be made in order of increasing frequency. In this regard, increasing frequency band index values may correspond to increasing frequency band frequency. In other exemplary embodiments of the invention, user assignments may be made in order of decreasing frequency. In this regard, increasing frequency band index values may correspond to decreasing frequency band frequency.

Various embodiments of the invention may comprise a method and system for determining a frequency band ordering for making user assignments among a plurality of frequency bands based on computed channel norm values.

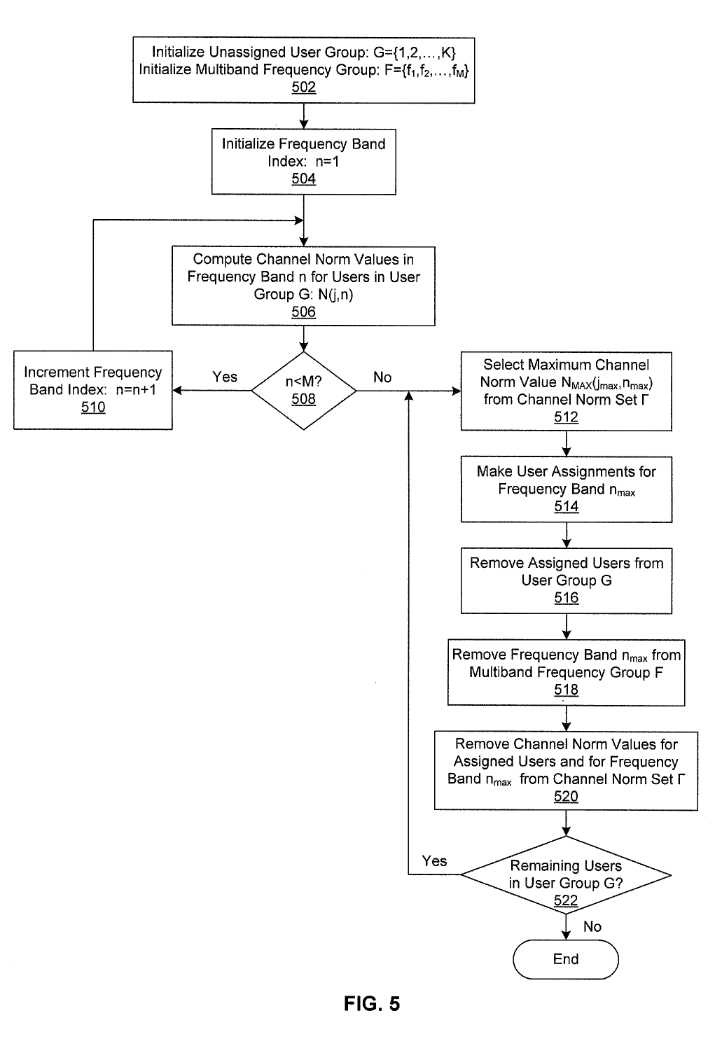

FIG. 5 is a flowchart that illustrates exemplary steps for frequency band ordering based on channel norm value for multiband user scheduling in a MU-MIMO communication system, in accordance with an embodiment of the invention. Referring to FIG. 5, in step 502, an unassigned user group, G, is initialized to comprise a set of K users and a multiband frequency group, F, is initialized to comprise the frequency bands in a multiband. In an exemplary embodiment of the invention, the initial frequency band ordering in frequency group F is according to increasing frequency such that f₁<f₂<L<f_{M}, where fₙ refers a frequency for the n^{th} frequency band, although any initial frequency ordering may be utilized. In step 504 a frequency band index is initialized, n=1. In step 506, a plurality of channel norm values is computed, N(j,n), where j is a user index (for values j=1, 2, . . . , K) and n is the frequency band index. The channel norm values, N(j,n), may be computed as shown in equation [6]. Step 508 determines whether n<M. When n<M, in step 510, the frequency band index is incremented. Step 506 follows step 510. When n≧M, the computation of channel norm values for the multiband is complete and step 512 follows step 508. The set of computed channel norm values may be represented as shown in the following equation:

r=(N(1,1),K,N(K,M)) [12]

In step 512, a maximum channel norm value, N_{MAX}(jₘₐₓ,nₘₐₓ), is selected from the computed channel norm values, N(j,n) in the channel norm set F, where jₘₐₓ is an index to a user in the user group G and nₘₐₓ is the frequency band for the maximum channel norm value in the channel norm set Γ. In step 514, user assignments are made for frequency band nₘₐₓ. In various embodiments of the invention, user assignments for frequency band nₘₐₓ may be made utilizing greedy user scheduling, modified greedy user scheduling or various other user scheduling methods. In step 516, users assigned to frequency band nₘₐₓ are removed from user group G. In step 518, frequency band nₘₐₓ is removed from multiband frequency group F. In step 520, channel norm values computed for the assigned users, across all frequency bands, are removed from channel norm set Γ. For example, when users i(1) and i(2) are assigned to frequency band nₘₐₓ, channel norm values N(i(1),n) and N(i(2),n), are removed from channel norm set Γ for all frequency bands, n, in the multiband frequency group F. In addition, channel norm values, N(j,nₘₐₓ), computed for frequency band nₘₐₓ across all users in user group G, are removed from channel norm set Γ. Step 522 determines whether there are remaining users in user group G. When there are additional users in user group G, step 512 follows step 522. When there are no additional users in user group G, the frequency band assignment process may terminate.

In various embodiments of the invention, the method and system for frequency band ordering disclosed herein may be utilized for making user assignments among a plurality of frequency bands when utilizing a greedy user scheduling algorithm, a modified greedy user scheduling algorithm or various other user scheduling algorithms, which may be utilized in connection with multiband user scheduling in a MU-MIMO communication system.

A processor 112 within an AP 202 may assign a plurality of users in a MU-MIMO system to a plurality of frequency bands in a multiband. In an exemplary embodiment of the invention, the AP 202 may assign a pair of users selected from a user group comprising a plurality of K users, for example STA 232a, 232b, . . . , 232n, to each of a plurality of M frequency bands as is shown in FIG. 3. For each frequency band in the multiband, the AP 202 may compute a channel norm for each user in the user group as shown in equation [6]. A plurality of candidate users, i(1), i(2) and i(3), may be selected based on the computed channel norm values as shown in equations [6]-[8]. A chordal distance value may be computed for a remainder of the user group as shown in equation [9]. The remainder of the user group may exclude candidate users i(1), i(2) and i(3). A subsequent plurality of candidate users, k(1) and k(2), from the remainder of the user group, may be selected based on the plurality of computed chordal distance values as shown in equations [9] and [10]. A plurality of channel capacity values may be computed based on the candidate users and subsequent candidate users as shown in equation [11].

In an exemplary embodiment of the invention, candidate pairings of the candidate users and subsequent candidate users may be formed and a channel capacity value may be computed for each candidate pairing. A plurality of assigned users for the current frequency band may be determined from the candidate users and subsequent candidate users based on a maximum channel capacity value selected from the plurality of computed channel capacity values. The plurality of assigned users in the current frequency band may be removed from the user group. A subsequent frequency band may be selected from the multiband.

The processor 112 within the AP 202 may determine a maximum channel norm value, a second largest channel norm value and a third largest channel norm value as shown in equations [6]-[8]. The first candidate user i(1) corresponds to the maximum channel norm value as shown in equation [6], the second candidate user i(2) corresponds to the second largest channel norm value as shown in equation [7], and the third candidate user i(3) corresponds to the third largest channel norm value as shown in equation [8]. The plurality of candidate users comprises the first candidate user, the second candidate user and the third candidate user.

The processor 112 within the AP 202 may compute a chordal distance value from the first candidate user for each of the remainder of the plurality of users as shown in equation [9]. A maximum chordal distance value may be determined among the plurality of computed chordal distance values. A first subsequent candidate user, k(1), may be determined based on the maximum chordal distance value. A subsequent chordal distance value may be computed for each of a portion of the remainder of the plurality of users as shown in equation [10]. The portion of the remainder of the plurality of users may exclude the first subsequent candidate user, k(1). A maximum subsequent chordal distance value may be computed among the plurality of computed subsequent chordal distance values. A second subsequent candidate user, k(2), may be determined based on the maximum subsequent chordal distance value. The subsequent plurality of candidate users may comprise the first subsequent candidate user and the second subsequent candidate user.

Another embodiment of the invention may provide a computer readable medium, having stored thereon, a computer program having at least one code section executable by a computer, thereby causing the computer to perform the steps as described herein for multiband user scheduling in a multiple user multiple input multiple output (MU-MIMO) communication system.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for processing signals, the method comprising:
performing by one or more processors and/or circuits:
for each of a plurality of frequency bands in a multiband:
computing a channel norm value, for a current frequency band in said multiband, for each of a plurality of users in a users group;
selecting a plurality of candidate users from said plurality of users based on said computed plurality of channel norm values;
computing a chordal distance value, for said current frequency band, for each of a remainder of said plurality of users, wherein said remainder of said plurality of users excludes said plurality of candidate users;
selecting a subsequent plurality of candidate users from said remainder of said plurality of users based on said computed plurality of chordal distance values; and
scheduling a plurality of assigned users for said current frequency band, wherein said plurality of assigned users is chosen from said selected plurality of candidate users and/or said selected subsequent plurality of candidate users.

2. The method according to claim 1, comprising determining a maximum channel norm value, a second largest channel norm value and a third largest channel norm value for said current frequency band.

3. The method according to claim 2, wherein a first candidate user corresponds to said maximum channel norm value, a second candidate user corresponds to said second largest channel norm value, and a third candidate user corresponds to said third largest channel norm value.

4. The method according to claim 3, wherein said plurality of candidate users comprises said first candidate user, said second candidate user and said third candidate user.

5. The method according to claim 3, comprising computing a first candidate chordal distance value, determined relative to said first candidate user, for said each of said remainder of said plurality of users.

6. The method according to claim 5, comprising determining a maximum chordal distance value based on said computed plurality of first candidate chordal distance values.

7. The method according to claim 6, comprising determining a first subsequent candidate user based on said determined maximum chordal distance value.

8. The method according to claim 7, comprising computing a second candidate chordal distance value, determined relative to said second candidate user, for each of a portion of said remainder of said plurality of users, wherein said portion of said remainder of said plurality of users excludes said first subsequent candidate user.

9. The method according to claim 8, comprising determining a subsequent maximum chordal distance value based on said computed plurality of second candidate chordal distance values.

10. The method according to claim 9, comprising determining a second subsequent candidate user based on said determined subsequent maximum chordal distance value.

11. The method according to claim 10, wherein said subsequent plurality of candidate users comprises said first subsequent candidate user and said second subsequent candidate user.

12. The method according to claim 1, comprising removing said plurality of assigned users, for said current frequency band, from said user group.

13. The method according to claim 12, comprising selecting a subsequent frequency band from said multiband.

14. A system for processing signals, the system comprising:
one or more circuit that enable, for each of a plurality of frequency bands in a multiband:
computation of a channel norm value, for a current frequency band in said multiband, for each of a plurality of users in a users group;
selection of a plurality of candidate users from said plurality of users based on said computed plurality of channel norm values;
computation of a chordal distance value, for said current frequency band, for each of a remainder of said plurality of users, wherein said remainder of said plurality of users excludes said plurality of candidate users;
selection of a subsequent plurality of candidate users from said remainder of said plurality of users based on said computed plurality of chordal distance values; and
scheduling of a plurality of assigned users for said current frequency band, wherein said plurality of assigned users is chosen from said selected plurality of candidate users and/or said selected subsequent plurality of candidate users.

15. The system according to claim 14, wherein said one or more circuits enable determination of a maximum channel norm value, a second largest channel norm value and a third largest channel norm value for said current frequency band.

16. The system according to claim 15, wherein a first candidate user corresponds to said maximum channel norm value, a second candidate user corresponds to said second largest channel norm value, and a third candidate user corresponds to said third largest channel norm value.

17. The system according to claim 16, wherein said plurality of candidate users comprises said first candidate user, said second candidate user and said third candidate user.

18. The system according to claim 16, wherein said one or more circuits enable computation of a first candidate chordal distance value, determined relative to said first candidate user, for said each of said remainder of said plurality of users.

19. The system according to claim 18, wherein said one or more circuits enable determination of a maximum chordal distance value based on said computed plurality of first candidate chordal distance values.

20. The system according to claim 19, wherein said one or more circuits enable determination of a first subsequent candidate user based on said determined maximum chordal distance value.

21. The system according to claim 20, wherein said one or more circuits enable computation of a second candidate chordal distance value, determined relative to said second candidate user, for each of a portion of said remainder of said plurality of users, wherein said portion of said remainder of said plurality of users excludes said first subsequent candidate user.

22. The system according to claim 21, wherein said one or more circuits enable determination of a subsequent maximum chordal distance value based on said computed plurality of second candidate chordal distance values.

23. The system according to claim 22, wherein said one or more circuits enable determination of a second subsequent candidate user based on said determined subsequent maximum chordal distance value.

24. The system according to claim 23, wherein said subsequent plurality of candidate users comprises said first subsequent candidate user and said second subsequent candidate user.

25. The system according to claim 14, wherein said one or more circuits enable removal of said plurality of assigned users, for said current frequency band, from said user group.

26. The system according to claim 25, wherein said one or more circuits enable selection of a subsequent frequency band from said multiband.
